(19) United States
(12) Patent Application Publication
(10) Pub. No.: US 2026/0176521 A1
(43) Pub. Date: Jun. 25, 2026

(54) MULTIFUNCTIONAL COMPOUNDS FOR ACTIVATION OF CEMENT FOR USE IN WELLBORES

(71) Applicant: Halliburton Energy Services, Inc., Houston, TX (US)

(72) Inventors: Thomas Jason Pisklak, Cypress, TX (US); Samuel J. Lewis, Spring, TX (US); Claudia Carmen Osegueda, Humble, TX (US); Chad Bryant Huffman, Houston, TX (US)

(21) Appl. No.: 19/000,905

(22) Filed: Dec. 24, 2024

(51) Int. Cl. C09K 8/467; C04B 18/162; C04B 22/06; C04B 22/10; C04B 22/14; C04B 28/04; C04B 40/00; C04B 103/10

(52) U.S. Cl. CPC C09K 8/467; C04B 18/162; C04B 22/062; C04B 22/10; C04B 22/143; C04B 28/04; C04B 40/0042; C04B 2103/10

(57) ABSTRACT

Provided herein are methods of producing a dry cement activator and related compositions. The method includes mixing water and a hydroxide containing inorganic to form a basic solution having a pH of greater than 10. An inorganic salt may be added to the basic solution and subsequently mixed for at least 5 minutes. The mixed solution may then be placed in an oven and dried for at least 24 hours at a temperature range of from 140° C. to 200° C. to form a dried cement activator powder. The dried cement activator powder is subsequently broken and further sized to produce a final activator product.

### TECHNICAL FIELD

The present disclosure relates generally to wellbore completion operations and, more particularly (although not necessarily exclusively), to multifunctional compounds for the activation of cement used in a wellbore completion operation.

### BACKGROUND

During completion of a wellbore, a casing string may be cemented to seal and fix the casing string in the wellbore. Cements used to seal and fix the casing string in the wellbore can include Portland cements and additives. Additives are used for altering the properties of the cement composition to accommodate various downhole conditions. However, producing and using a complex cement composition may result in increased cost, increased wait on cure times, and reduced cement strength. The delayed cement strength development, or further uneven cement curing can cause the cement to have poor zonal isolation. In some cases, the cement can become de-bonded and separate from the casing. The separation can create a void space around the casing called a micro-anulus. Zonal isolation may be lost as oil and gas produced in the wellbore may migrate through the micro-annuli. These effects may be exacerbated in cement compositions having a reduced Portland cement concentration.

### BRIEF DESCRIPTION OF THE DRAWINGS

FIG. 1 is a schematic of a wellbore in which a completion operation is occurring according to one example of the present disclosure

FIG. 2 is a block diagram of an example method for producing an activatable cement composition according to one example of the present disclosure.

FIG. 3 is a scanning electron microscopy (SEM) image of example 1 supplementary cementitious material (SCM) activator, according to one example of the present disclosure.

FIG. 4 is a graph of the compressive strength (in PSI) of comparative example 1 and example 1 SCM activator as measured using an ultrasonic cement analyzer (UCA), according to one example of the present disclosure.

FIG. 5A is a scanning electron microscopy (SEM) image of example 2 SCM activator composition, according to one example of the present disclosure.

FIG. 5B is a scanning electron microscopy (SEM) image of example 3 SCM activator composition, according to one example of the present disclosure.

FIG. 6 is a graph of the compressive strength (in PSI) of comparative example 1, example 2 SCM activator, and example 3 SCM activator as measured using an ultrasonic cement analyzer, according to one example of the present disclosure.

FIG. 7 is a scanning electron microscopy (SEM) image of example 4 SCM activator composition, according to one example of the present disclosure.

FIG. 8 is a graph of the compressive strength (in PSI) of comparative example 1, example 1 SCM activator, example 3 SCM activator, and example 4 SCM activator as measured using an ultrasonic cement analyzer, according to one example of the present disclosure.

### DETAILED DESCRIPTION

Certain aspects and examples of the present disclosure relate to methods and multifunctional compounds for activating cements that include low percentages of Portland cement and low heat Portland cements. Additionally described herein are multifunctional dry activators for cements in low temperature environments. Portland cements are one of the most common types of cements used around the world as a basic ingredient of cement compositions. Portland cements can be divided into 5 classifications including ordinary Portland cement (type I), rapid hardening Portland cement (type III), low heat Portland cement (type IV), sulfate-resisting cement (type V), and blast furnace cement (type IS). However, cement compositions containing low Portland cement concentrations (i.e., less than 50% by weight of the blend) and further including greater than 50 wt. % supplementary cementitious material (SCM) can result in increased set times and delay strength development of the blends. The set times and strength development may be further exacerbated in low temperature environments, such as less than 150° F.

SCM activation may be used to describe the modification of pozzolanic materials with the goal of increasing overall cementitious reactivity. Methods of SCM activation can be classified into three typical categories including thermal, mechanical, and chemical. Chemical activation may be the most economically friendly method and may be achieved by the use of various types of chemicals. Some chemicals that may be employed may have drawbacks including transportation issues, storage issues, and increasing the potential exposure to hazardous material. Other negative properties the chemicals might impart on the product may include increased gelation, and negative rheological effects on the cement. Thus, activator compositions and methods of producing the like are desired.

Supplementary cementitious material types can include industrial by-products, natural pozzolans, and calcined clays which can exhibit hydraulic or pozzlanic properties under the right conditions. For example, SCMs can include soluble siliceous, aluminosiliceous, or calcium aluminosiliceous powders. The SCMs can be used as chemical crosslinkers in cements or as partial replacements of Portland cements in cement compositions. Further, pozzolans include siliceous or siliceous and aluminous material that in itself possesses little or no cementitious value, but in a finely divided form and in the presence of moisture, chemically react with calcium hydroxide at ordinary temperatures to form compounds having cementitious properties. Described herein are novel multifunctional compositions and methods of producing the cement compositions.

In some embodiments, the dry cement activator composition described herein may be produced from a solution having a pH of greater than 10, an inorganic salt, and at least one additive. The produced activator may be added to a cement composition having less than 50% Portland cement by weight of a cement composition. The dry cement activator compositions described herein can enable the cements, as described herein, to activate or be activated at temperatures of below 150° F. Additionally, including the dry cement activator compositions described herein with the cement composition may result in a compressive strength of greater than 50 PSI in under 3 hours.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

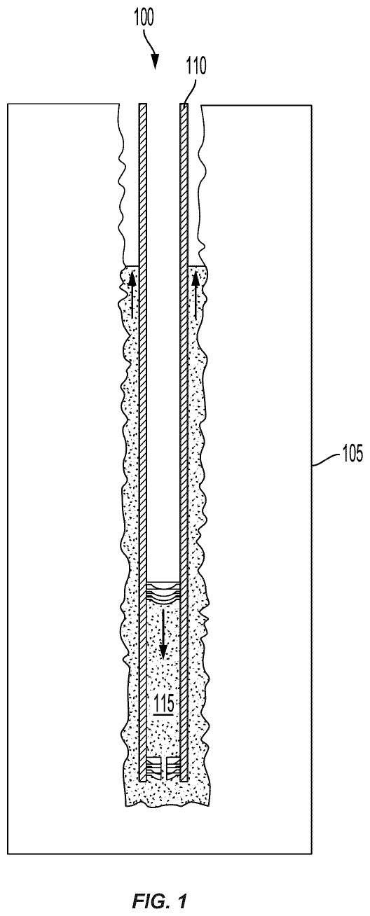

FIG. 1 is a schematic of a wellbore 100 in which a completion operation is occurring according to one example of the present disclosure. The wellbore 100 can extend through various earth strata and can extend through or to a hydrocarbon bearing subterranean formation 105. Although the wellbore 100 depicted in FIG. 1 is substantially vertical, other orientations for sections of the wellbore 100 can be used, including curved, angled, or substantially horizontal. The wellbore 100 includes a casing string 110. A cement mixture 115 is used to fix the casing string 110 in place within the wellbore 100 as part of a completion operation. As illustrated, the cement mixture 115 is directed downhole within the casing string 110 using a pair of wiper plugs to force the cement mixture 115 into an annular space between the wellbore 100 and the casing string 110.

The cement mixture 115 can include a cement slurry. The cement slurry can include supplementary cementitious material and a dry cement activator. In some embodiments, the slurry composition can include more than 50% supplementary cementitious material in a low concentration Portland cement. For example, a low concentration Portland cement can include a cement slurry having less than 50% Portland cement. By including the supplementary cementitious material (SPM) and the dry cement activator within the cement slurry 115, aspects of the above features can be achieved, as will be described in more detail below.

Although FIG. 1 shows a single casing string 110, multiple casing strings can be used within the wellbore 100, such as a surface casing string, an intermediate casing string, or a production casing string. In some cases, a liner suspended from inside the bottom of another casing string may be used. Further, cement mixtures 115 can be used for wellbore completion operations other than cementing a casing string 110 or for other wellbore operations. As examples, resins and polymers may also be used in the cement mixture 115, such as for lost circulation material, as part of a cement sheath, for remediating an existing cement sheath, or the like. In some embodiments, the cement mixture may be a low Portland cement mixture.

In some embodiments, a cement component (e.g., Portland cement) in the cement mixture 115 and/or the cement mixture 115 itself may have delayed strength developments that may be exacerbated in low temperature environments or when the concentration of SCM is greater than 50% in the Portland cement. As noted above, including the dry cement activator in the cement mixture 115 may be useful for accommodating or otherwise counteracting the delayed strength development of the cement mixture 115 during curing. For example, the dry cement activator may react with the SCMs added in the low concentration Portland cements, causing the cement slurry to have an increase in strength development and lower slurry gelation rates.

Cement compositions having lower concentrations of Portland cement can include higher concentrations of SCMs to reduce the carbon footprint and reduce the cost of production. However, increasing the amount of SCMs in the cement slurry may increase set times and delay the strength development of the blended cement slurry 115. Increasing SCM loading may further increase the gelation of the cement slurry, increase the set time and delay the strength development. In downhole environments having a temperature of below 150° F., the cement slurry 115 may be further impacted. In some embodiments, adding the dry cement activator into the cement slurry 115 may allow the slurry composition to be utilized in temperature ranges below 150° F. For example, the cement slurry may be activatable at temperatures below 150° F., below 140° F., below 130° F., below 120° F., below 110° F., or below 100° F. Furthermore, using the dry cement activator as described herein may allow for increasing the concentration of SCMs in the cement slurry. Increasing the amount of SCMs can allow for decreasing the amount of Portland cement in the cement slurry 115.

In some embodiments, the dry cement activator may be included in the cement mixture 115 and may reduce the set time of the cement mixture and improving the delayed strength of the cement during drying. The dry cement activator may be homogeneously distributed within the cement mixture 115 to ensure even strength development of the cement mixture 115 allowing for a uniform set time and thus reducing the chances of the cement cracking.

The term “low Portland cement” refers to a cement composition having less than 50% Portland cement by weight of the blend. Additionally, the term “high Portland cement” refers to a cement composition having greater than 50% Portland cement by weight of the blend. For example, a “low Portland cement” includes cement compositions having 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% Portland cement by weight of the blend.

Following drilling of the wellbore 100, a casing may be cemented into the wellbore 100 by introducing cement into an annular space between the wellbore 100 and the wellbore casing string 110. Once the cement has set and the casing is secured into place, the wellbore may be used for production operations. In some embodiments, the setting time of the cement may directly impact the cost of operation and cost of producing the well. For example, if the set time is too long, the cost of labor may be high due to the long waiting time. In some embodiments, the dry cement activator as described herein may reduce the setting time of the cement thus reducing cost while maintaining high strength. The SCM dry cement activator and method of producing the SCM dry cement activator as described further below, may be employed in any cement composition during any operations which may include the use of a cement.

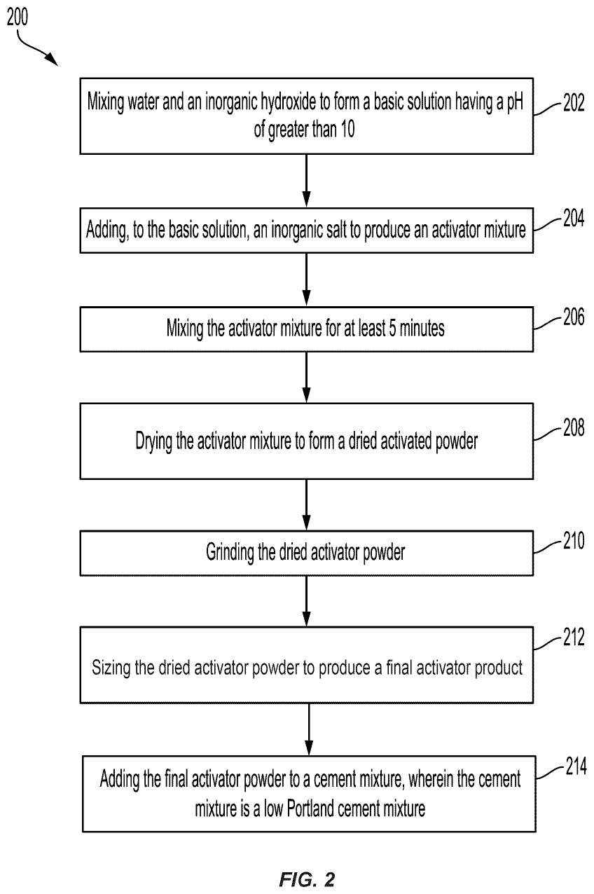

For example, the composition for improving an activation of the cement can be produced from a solution having a pH of greater than 10, an inorganic salt, and at least one additive. The at least one additive may be selected from a viscosifier, an accelerator, or a dispersant. The dry cement activator composition can be added to a cement composition having less than 50% Portland cement by weight of the cement composition. An example of a method of producing the dry cement activator composition and furthermore, the cement slurry composition, is shown in FIG. 2.

FIG. 2 is a block diagram of an example method 200 for producing an activatable cement composition according to one example of the present disclosure. At block 202, the method 200 may include first mixing water and an inorganic hydroxide to form a basic solution having a pH of greater than 10. The hydroxide may be derived from sodium hydroxide, potassium hydroxide, lithium hydroxide, barium hydroxide, calcium hydroxide, ammonium hydroxide, rubidium hydroxide, magnesium hydroxide, or any combination thereof. In some embodiments, the concentration of the hydroxide may be at least 50% by weight of solution.

In some embodiments, the hydroxide may be at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40% at least 41%, at least 42%, at least 43%, at least 44%, at least 45%, at least 46%, at least 47%, at least 48%, at least 49%, at least 50%, at least 51%, or at least 52%. The weight % (wt. %) of solution may be further defined by the amount of solid added to an amount of water. For example, a 50 wt. % of inorganic hydroxide may be understood by those skilled in the art as 100 grams of the inorganic hydroxide dissolved in 100 grams of water. Alternatively, those skilled in the art may further calculate the molarity of the hydroxide solution based at least in part on the molar mass of the inorganic hydroxide. For example, a 50 wt. % sodium hydroxide solution may have a molarity of 19.1 molar (M).

The term “inorganic hydroxide” may refer to alkaline salts formed by treating oxides with water or via decomposing salts by adding other soluble hydroxides to a solution thereof or refer to compounds that includes hydroxides of alkali and alkali earth metals. Inorganic hydroxides can include sodium hydroxide, potassium hydroxide, lithium hydroxide, barium hydroxide, calcium hydroxide, ammonium hydroxide, rubidium hydroxide, and magnesium hydroxide. The term “hydroxide” may refer to a diatomic anion with the chemical formula OH consisting of an oxygen atom and a hydrogen atom. Inorganic hydroxides may be readily soluble in water.

At block 204, the method 200 may include adding, to the basic solution, an inorganic salt to produce a dry cement activator solution. The inorganic salt may be selected from a group including calcium carbonate, cement kiln dust, calcium sulfate, calcium phosphate, sodium phosphate, calcium silicate, or any combination thereof. In some embodiments, the inorganic salt may be any inorganic salt that has a low water solubility. In some embodiments, the inorganic salt may be referred to as a substrate material. The substrate material may be included in an amount of from 10 wt. % to 90 wt. % by weight of the dry cement activator composition. For example, the substrate material may be included in an amount of about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. %, about 89 wt. %, or about 90 wt. % by weight of the dry cement activator composition.

Various other additives may be introduced into the dry cement activator composition. The additives may include dispersing agents or dispersants that may be selected from a group including polycaboxylate ethers, a combination of sodium formate and sulfonic acid salt, naphthalene formaldehyde sulfonated condensate, acetone formaldehyde sulfonated condensate, or any combination thereof. Polycarboxylate ethers are organic compounds that have more than one carboxylic acid group and in some instances include ethylene oxide pendants. Such addititives may reduce the density of the cement slurry during mixing. For example the cement slurry may have a density of from about 5 lbs/gallon to about 25 lbs/gallon. In some embodiments, the density of the cement slurry may be about 5 lbs/gallon, 6 lbs/gallon, 7 lbs/gallon, 8 lbs/gallon, 9 lbs/gallon, 10 lbs/gallon, 11 lbs/gallon, 12 lbs/gallon, 13 lbs/gallon, 14 lbs/gallon, 15 lbs/gallon, 16 lbs/gallon, 17 lbs/gallon, 18 lbs/gallon, 19 lbs/gallon, 20 lbs/gallon, 21 lbs/gallon, 22 lbs/gallon, 23 lbs/gallon, 24 lbs/gallon, or 25 lbs/gallon.

In some embodiments, accelerating materials may be included in the dry cement activator composition. Accelerating materials, or referred to as accelerators, may include sodium chloride, calcium chloride, sodium silicate, sodium sulfate, sodium aluminate, sodium hexametaphosphate or any combination thereof. The accelerating material may be added to the dry cement activator material to increase the rate of strength development for the cement. In some embodiments, the accelerators may not absorb water or carbon dioxide thus reducing the cost of production and increasing shelf life and safety.

In some embodiments, the dry cement activator described herein may be combined with other substrates such as calcium carbonate, calcium sulfate, or cement kiln dust to produce an alternate dry cement activator compound that may be included in cement compositions that include greater than 50% of Portland cement. The composition may further include an SCM to produce a more complex multifunctional dry cement activator. In some examples, the cement can be a hydraulic cement and can include one or more of Portland cement, a pozzolana cement, a gypsum cement, a high alumina content cement, a slag cement, high magnesia content cement, shale cement, acid or base cement, fly ash cement, a zeolite cement system, a kiln cement system, microfine cement, metakaolin, or pumice. In some embodiments, the cement composition may further include other SCMs, such as perlite. In some embodiments, other SCMs may be used in the cement composition.

At block 206, the method 200 may include mixing the activator, including any additional components as described above, for at least 5 minutes to facilitate the production of a homogenous mixture. In some embodiments, the mixing may be performed for up to 1 hour. In some embodiments, the mixing may be performed in a standard cement mixer at from about 3 rotations per minute to 300 rotations per minute.

The method 200 may further include drying, at block 208, the solution to form a dried cement activator mixture. In some embodiments, drying the activator mixture may include baking the activator mixture in an oven for at least 24 hours at a temperature range of from about 140° F. to about 200° F. to form a dried activated powder. In some embodiments, the temperature may be about 140° F., about 145° F., about 150° F., about 155° F., about 160° F., about 165° F., about 170° F., about 175° F., about 180° F., about 185° F., about 190° F., about 195° F., or about 200° F. In yet other embodiments, the activator composition may be baked at temperatures greater than 200° F.

Following drying of the activator, the method 200 may include grinding the dried activator powder, at block 210, into smaller pieces by mechanical processing methods, such as grinding. For example, the dried cement activator may be physically broken into smaller pieces by industrial techniques for producing powders. For example, the method may include grinding the solids to produce the final activator powder. In some embodiments, the ground powder may have a number average particle diameter of less than 300 microns. For example, less than 275 microns, less than 250 microns, less than 225 microns, less than 200 microns, less than 175 microns, less than 150 microns, less than 125 microns, less than 100 microns, less than 75 microns, or less than 50 microns.

At block 212, the method 200 may include sizing the dried cement activator powder to produce a final product. The dried cement activator as described herein, may be further referred to as an SCM activator as described below. In some embodiments, sizing may be performed via passing the powder through a sieve to produce a more uniform composition. For example, the sieve may have pores ranging in size of from 3 micron to about 300 micron. For example, the sieve may be selected to produce a uniform diameter powder. For example, to produce a powder having a diameter less than 300 microns, the pore size of the sieve may be 300 micron. In some embodiments, the sieve may have a diameter of about 3 micron, about 4 micron, about 5 micron, about 6 micron, about 7 micron, about 8 micron, about 9 micron, about 10 micron, about 11 micron, about 12 micron, about 13 micron, about 14 micron, about 15 micron, about 16 micron, about 17 micron, about 18 micron, about 19 micron, about 20 micron, about 21 micron, about 22 micron, about 23 micron, about 24 micron, about 25 micron, about 26 micron, about 27 micron, about 28 micron, about 29 micron, about 30 micron, about 31 micron, about 32 micron, about 33 micron, about 34 micron, about 35 micron, about 36 micron, about 37 micron, about 38 micron, about 39 micron, about 40 micron, about 41 micron, about 42 micron, about 43 micron, about 44 micron, about 45 micron, about 46 micron, about 47 micron, about 48 micron, about 49 micron, or about 50 micron. In some embodiments, the sieve may have a diameter of about 60 microns, about 70 microns, about 80 microns, about 90 microns, about 100 microns, about 110 microns, about 120 microns, about 130 microns, about 140 microns, about 150 microns, about 160 microns, about 170 microns, about 180 microns, about 190 microns, about 200 microns, about 210 microns, about 220 microns, about 230 microns, about 240 microns, about 250 microns, about 260 microns, about 270 microns, about 280 microns, about 290 microns, or about 300 microns. In some embodiments, sizing may be performed via sieving, cyclonic separation, air classification, or sifting.

The term “sizing” may refer to a process for separating or sorting dried materials from one another based upon the diameter of the material. Sizing may include mechanical or chemical methods known by those skilled in the art to sort a material by a measured parameter.

At block 214, the final dry cement activator product may be added to a low Portland cement mixture and may reduce the set time of the low Portland cement mixture. The cement composition may have less than 50% Portland cement by weight of the blended cement composition. For example, the cement composition may have 40% Portland cement by weight of the blended cement composition. In some embodiments, the cement composition may include 30% Portland cement by weight of the blended cement composition. For example, the cement composition may have 20% Portland cement by weight of the blended cement composition. In some embodiments, the cement composition may have less than 20% Portland cement by weight of the blended cement composition. In some embodiments, the dry cement activator powder may be produced, shipped, and delivered to a job site before being combined with the cement composition for producing the cement slurry. In some embodiments, other additives may be added to the cement slurry to further alter the properties of the cement slurry. In some embodiments, the dry cement activator composition may be added to the cement composition in an amount from about 5% by weight of the blend (BWOB) to about 30% BWOB. For example, the dry cement activator may be added to the cement composition at an amount of from about 5%, about 10%, about 15%, about 20%, about 25%, or about 30% BWOB. In some embodiments, the one or more SCM may be included in the cement slurry from about 25% to about 85% BWOB. For example, from about 30% to about 80% BWOB. In some embodiments, the one or more SCM may be greater than 35% BWOB, greater than or about 40% BWOB, greater than or about 45% BWOB, greater than or about 50% BWOB, greater than 55% BWOB, or greater than or about 60% BWOB.

In some embodiments, the dry cement activator and cement mixture may be used to produce a slurry. The slurry may be used in completion operations, cementing operations, or a combination thereof. For example, the cement slurry mixture, including the dry cement activator, may be positioned downhole within a wellbore during cementing operations to seal the annulus after a casing string has been run. In some embodiments, the cementing operation can include cementing a casing string in a wellbore to allow for securing the casing within the wellbore. Additionally, the cement mixture may be used for controlling lost circulation zones within one or more wellbore.

Other such additives may include fluid loss additives, viscosifiers, and accelerating materials. In some embodiments, the fluid loss additives include polyacrylamide copolymer, polyvinyl alcohol, a combination of sodium hydroxide and acrylic resin, derivatives of polyvinyl alcohol, or any combination thereof. The fluid loss additives may be included in the cement composition in an amount of from about 10 wt. % to about 40 wt. %.

Viscosifiers may be added to the cement slurry composition to further adjust the viscosity of the cement slurry. In some embodiments, the viscosity may be altered at temperatures of below 140° F. The viscosifiers may include polysaccharide biopolymer, hydroxyethyl cellulose and derivatives, or a combination thereof. In some embodiments, the viscosifiers may be included in the cement composition in an amount of from about 0.10 wt. % to about 10 wt. %. In some embodiments, the fluid loss additives, the viscosifiers, and additional SCMs may be added to the dry cement composition after the addition of the dry cement activator and water to produce a cement slurry.

A “dry cement composition” or “dry cement mixture” refers to a cement mixture and/or composition that does not contain any water. The mixture and/or composition includes a blend of cement, aggregates, and any other dry components that may be transported to sites as a dry composition.

The methods described herein may be used to produce a cement composition having controllable properties for cementing operations. For example, the method described herein may produce a cement composition that has a viscosity of less than 3750 centipoise (cP) when mixed at 100 RPM. In some embodiments, the viscosity may be less than 3000 cenitpose, less than 2500 cenitpose, less than 2000 cenitpose, less than 1500 centipoise, less than 1000 centipoise, less than 600 centipoise, or less than 400 centipoise when mixed at 100 RPM. The viscosity of the cement composition may be adjusted by including or removing any one of the additives as described above. In some embodiments, the viscosity may be adjusted for a particular job site to enable adequate use and operation of the cement composition.

The dry cement activator may be included in the cement composition to further improve the compressive strength of the cement. Cement compositions for use in wellbore operations may have benchmarks to meet or exceed customer expectations. For example, in wellbore operations, the cement composition may have a strength of at least 50 PSI for applicability. The cement composition described herein, including the dry cement activator composition as described, may have a compressive strength of greater than 50 PSI when measured at 3 hours. In some embodiments, the composition described herein may have a compressive strength of greater than 150 PSI when measured at 24 hours.

In some embodiment, the final cement composition may be activatable at temperatures of below 150° F. For example, the cement may be activatable at a temperature of below 140° F., below 130° F., below 120° F., below 110° F., below 100° F., below 90° F., below 80° F., below 70° F., or below 60° F. In some embodiments, the compositions and methods described herein may overcome the difficulties as described above. For example, the compositions and methods described herein may produce cements having decreased strength set times, and activatable in low temperature environments. The compositions and methods may be used in cement compositions having high amounts of SCMs and lower amounts of Portland cement. Thus making the compositions and methods more environmentally friendly by reducing the carbon footprint of the product.

### EXAMPLES

### Example 1: SCM Activator 1 Produced from Sodium Hydroxide and Calcium Carbonate

To produce example 1 SCM activator for testing, a sodium hydroxide (NaOH) solution was first prepared by dissolving 100.0 g NaOH flakes in 100.0 g deionized (DI) water. The solution was cooled to room temperature (RT) before use. The calcium carbonate used in the production of example 1 SCM activator was from 50 micron ground marble.

For SCM Activator preparation (Example 1 SCM Activator), calcium carbonate was placed in a plastic beaker and 50% NaOH solution was poured over the powder. The concentrations are provided in Table 1, below. The calcium carbonate powder and 50% NaOH solution mixture was thoroughly stirred to ensure homogenous mixing. The open plastic beaker was subsequently placed in an oven at 160° F. After 24 hours, the beaker was removed and a solid white crystalline material was obtained. The material was mechanically broken into small, (˜10 mm) pieces and ground using a mortar and pestle. The resulting powder was then sized using a 50 mesh screen to obtain powdered activator.

TABLE 1
Starting components utilized to
produce Example 1 SCM Activator.

| Material | Wt. (g) | Wt. % |
|---|---|---|
| 50% NaOH Solution | 79.98 | 44.0 |
| Calcium Carbonate | 100.09 | 56.0 |

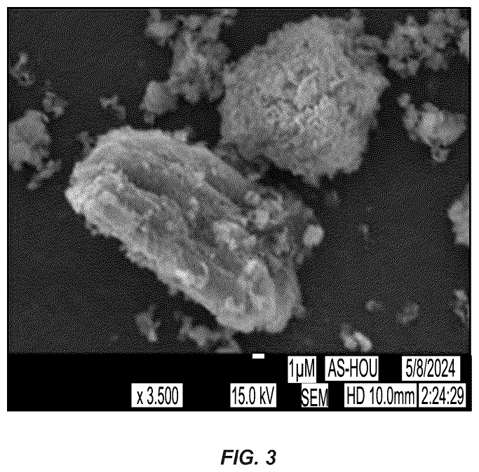

FIG. 3 is a scanning electron microscopy (SEM) image of an example supplementary cementitious material (SCM) activator made from sodium hydroxide and calcium carbonate (example 1), according to one example of the present disclosure. As shown in FIG. 3, the activator comprised agglomerates of very small particles.

Two cement slurry formulations were prepared to evaluate the SCM Activator's effectiveness at enhancing strength development in low Portland cements. As shown in Table 2 below, the comparative Example 1 slurry was prepared from Portland cement, perlite, and water. Example 1 SCM Activator 1 slurry was prepared from the same materials and further included the example 1 SCM activator. The measured densities were determined to be almost identical (e.g., 13.90 and 13.99, respectively).

TABLE 2
Formulation of conventional low Portland cement (Comparative Example
1) with 20% Portland content containing Perlite as the SCM.

| | Comparative | | Example 1 SCM | |
|---|---|---|---|---|
| | Example 1 Slurry | | Activator Slurry | |
| | % | Wt. | % | Wt. |
| Material | BWOB | (g) | BWOB | (g) |
| Portland Cement, Class | 20 | 64.0 | 20 | 64.0 |
| H | | | | |
| Perlite (SCM) | 80 | 256.0 | 80 | 256.0 |
| Water | 55 | 176.0 | 55 | 176.0 |
| Example 1 SCM | — | — | 10 | 32.0 |
| Activator | | | | |
| Slurry Density (ppg) | 13.90 | — | 13.99 | |

The slurries were prepared following standard cement practices. For example, dry components were weighed into a glass container having a clean lid and agitated by hand until blended. Tap water was then weighed into a Waring blender jar. The dry components and water were then blended per API procedure to form slurries. Immediately after blending the rheology's were taken at RT on a Fann RheoVADR® rheometer with bob and sleeve attachment. Concurrently, the slurries were poured into a UCA sleeve and compressive strengths were measured with an ultrasonic cement analyzer (UCA) set at 80° F. and 3000 psi.

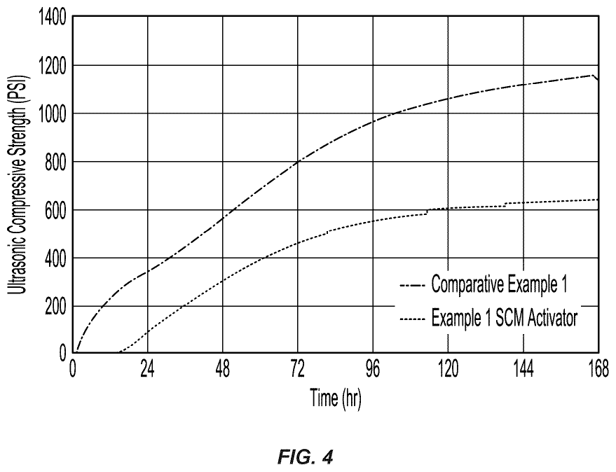

The data in FIG. 4 and Tables 3 and 4 show that the addition of SCM Activator 1 to low Portland cements substantially increases the rate and ultimate value of compressive strength development. FIG. 4 is a graph of the compressive strength (PSI) of a comparative example 1 and example 1 SCM activator as measured using an ultrasonic cement analyzer, according to one example of the present disclosure. The results of both FIG. 4 and Table 3 demonstrate the rheology was slightly improved in example 1 as compared to comparative example 1. For example, example 1 SCM activator slurry demonstrated a UCA of 348 psi after 24 hours while comparative example 1 demonstrated only a 101 psi in the same time frame. Table 4 demonstrates the viscosity (in cP) measured at different rotations per minute (RPM). As measured in Table 4, the cP of example 1 SCM Activator was 315 cP as compared to comparative example 1 measuring 779 cP at the same RPM. The results of the density measurements demonstrate example 1 SCM activator prepared in a cement composition performs at a lower viscosity as compared to a cement composition that includes comparative example 1. The lower viscosity may make the cement composition more suitable for handling and applications in wellbore environments.

TABLE 3
Key compressive strength measurements from UCA comparison.

| | Time at 50 | 24 hr. UCA | 72 hr. UCA | 7 Day UCA |
|---|---|---|---|---|
| Slurry | psi (hh:mm) | C.S. (psi) | C.S. (psi) | C.S. (psi) |
| Control | 19:35 | 101 | 466 | 646 |
| SCM Activator | 1:52 | 348 | 800 | 1138 |
| 1 Slurry | | | | |

TABLE 4
Comparison of apparent viscosity (AVIS) of Example
1 SCM Activator and Comparative Example 1 slurries.

| | AVIS Values at Specified RPM | | | | | | |
|---|---|---|---|---|---|---|---|
| | 3 | 6 | 30 | 60 | 100 | 200 | 300 |
| | rpm | rpm | rpm | rpm | rpm | rpm | rpm |
| Slurry | (cP) | (cP) | (cP) | (cP) | (cP) | (cP) | (cP) |
| Comparative | 5158 | 3550 | 1491 | 1026 | 779 | 536 | 431 |
| example 1 | | | | | | | |
| SCM | 4348 | 2424 | 700 | 435 | 315 | 211 | 171 |
| Activator 1 | | | | | | | |
| Slurry | | | | | | | |

### Example 2: SCM Activators Composed of Various Substrates

Substrates other than calcium carbonate were also tested in cement compositions using the methods described herein to produce effective SCM activators. For example, shown in Tables 5 below are example 2 SCM Activator and example 3 SCM Activator compositions using calcium sulfate hemihydrate and cement kiln dust, respectively. The compositions were prepared to determine whether alternate substrates may be used for the production of effective activators for use in cements including higher concentrations of SCMs. For example, example 3 SCM Activator includes a polycarboxylate ether (PCE) dispersant in the composition of the activator.

TABLE 5
Formulations of Example 2 SCM Activator
and Example 3 SCM Activator.

| | Material | Wt. (g) | Wt. % |
|---|---|---|---|
| Example 2 SCM | 50% NaOH Solution | 79.98 | 23.0 |
| Activator | Calcium Sulfate | 136.14 | 77.0 |
| | Hemihydrate | | |
| Example 3 SCM | 50% NaOH Solution | 79.98 | 44.0 |
| Activator | Cement Kiln Dust | 46.5 | 51.0 |
| | PCE Dispersant | 10.0 | 5.0 |

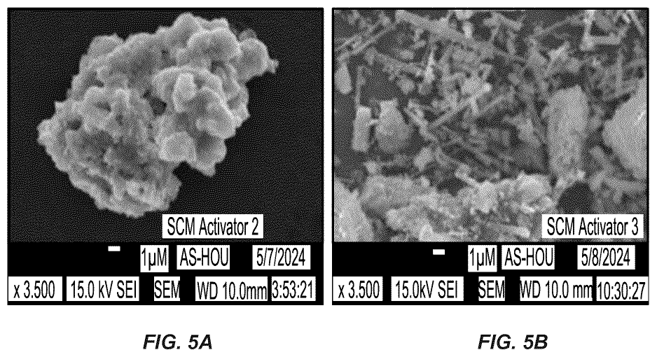

The solid activators were synthesized following the same method for preparing example 1 SCM Activator to form powdered activators. FIG. 5A is a scanning electron microscopy (SEM) image of an example 2 SCM activator composition, according to one example of the present disclosure. FIG. 5B is a scanning electron microscopy (SEM) image of example 3 SCM activator composition, according to one example of the present disclosure. The SEM images of both FIGS. 5A and 5B demonstrate successful production of SCM activators having a particle size of less than 50 microns.

Cement slurries were prepared from example 2 and example 3 SCM activators using the above methods and includes the formulations as described in Table 6. The compositions were prepared from Portland cement, perlite, water, and example 2 and example 3 SCM activator, respectively. Interestingly, the slurries have almost identical densities as measured in ppg.

TABLE 6
Formulations of low Portland cement with 20% Portland content
and 10% example 2 SCM Activator or 10% example 3 SCM activator.

| | Example 2 SCM | | SCM Activator 3 | |
|---|---|---|---|---|
| | Activator Slurry | | Slurry | |
| Material | % BWOB | Wt. (g) | % BWOB | Wt. (g) |
| Portland Cement, Class | 20 | 64.0 | 20 | 64.0 |
| H | | | | |
| Perlite | 80 | 256.0 | 80 | 256.0 |
| SCM Activator 2 | 10 | 32.0 | — | — |
| SCM Activator 3 | — | — | 10 | 32.0 |
| Water | 55 | 176.0 | 55 | 176.0 |
| Slurry Density (ppg) | 14.16 | | 13.91 | |

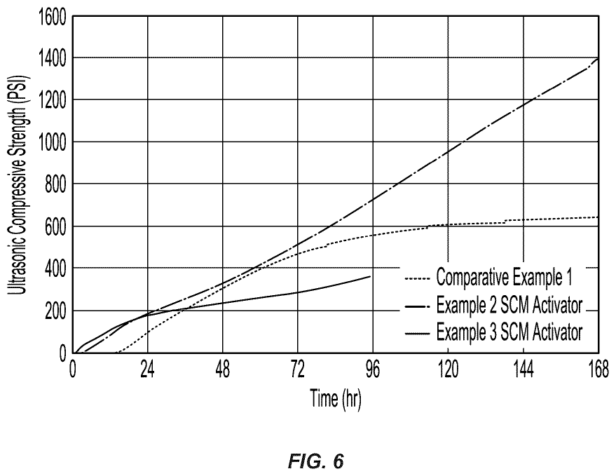

Immediately after blending, the slurries were poured into ultrasonic cement analyzers (UCAs) and the compressive strengths were measured at 80° F. and 3000 psi. FIG. 6 is a graph of the compressive strength (PSI) of comparative example 1, example 2 SCM activator, and example 3 SCM activator as measured using an ultrasonic cement analyzer, according to one example of the present disclosure. The results in FIG. 6 and Table 7 demonstrate that the addition of example 2 SCM Activator and example 3 SCM Activator to low Portland cements increases the rate and ultimate value of compressive strength development when compared against comparative example 1 which includes no activator. For example, SCM activator 2 demonstrated a compressive strength of 512 PSI after 72 hours while comparative example 1 measured at 466 PSI. Additionally, after 7 days, comparative example 1 reached a maximum of 646 PSI and example 2 SCM activator measured 1387 PSI. Additionally, the results demonstrate that the addition of other additives, such as PCE dispersants in example 3 SCM, may be incorporated into the activator composition for altering the properties of the SCM.

TABLE 7
Key compressive strength measurements from UCA comparison.

| | Time at | | | |
|---|---|---|---|---|
| | 50 psi | 24 hr. UCA | 72 hr. UCA | 7 Day UCA |
| Slurry | (hh:mm) | C.S. (psi) | C.S. (psi) | C.S. (psi) |
| Comparative | 19:35 | 101 | 466 | 646 |
| Example 1 | | | | |
| Example 2 SCM | 7:36 | 192 | 512 | 1387 |
| Activator Slurry | | | | |
| Example 3 SCM | 4:38 | 181 | 290 | 430 (5 day) |
| Activator Slurry | | | | |

### Example 3: SCM Activator Compositions Including Additional Additives

To demonstrate the applicability of the methods and compositions described herein, SCM activators were prepared to include additional additives. One way that this can be accomplished is by including other functional additives in the formation reaction. For example, example 3 SCM Activator further includes a dispersant to help control and reduce slurry viscosity, as shown in Table 5, above). SCM Activator 4, includes two cement accelerators to accelerate strength development and a dispersant to reduce slurry viscosity.

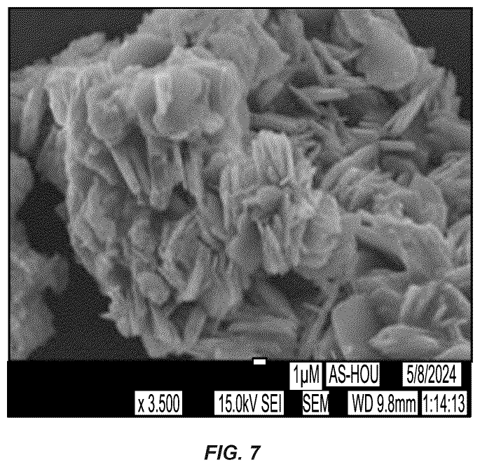

SCM Activator 4 was synthesized following the same method for the production of example 1 SCM Activator to form a powdered activator. FIG. 7 is a scanning electron microscopy (SEM) image of example 4 SCM activator composition, according to one example of the present disclosure. FIG. 7 demonstrated that the particles produced from example 4 SCM activator composition are smaller than 50 microns in diameter. Additionally, as compared to the other activators above, the activator prepared from example 4 SCM presented with a smooth surface with a relatively uniform shape.

TABLE 8
Starting components utilized to
produce Example 4 SCM Activator.

| Material | Wt. (g) | Wt. % |
|---|---|---|
| 50% NaOH Solution | 79.98 | 36.0 |
| CaCO3 | 93.0 | 42.0 |
| Sodium Sulfate | 25.0 | 11.0 |
| NaCl | 25.0 | 11.0 |
| PCE Dispersant | 10.0 | 4.0 |

A cement slurry produced including example 4 SCM Activator was prepared following the same procedures as above. The formulation is described below in Table 9. Immediately after blending, the slurries were poured into UCAs and the compressive strengths were measured at 80° F. and 3000 psi.

TABLE 9
Formulation of low Portland cement with 20%
Portland content and 10% SCM Activator 4.

SCM Activator 4
Slurry

| Material | % BWOB | Wt. (g) |
|---|---|---|
| Portland Cement, Class | 20 | 64.0 |
| H | | |
| Perlite | 80 | 256.0 |
| SCM Activator 4 | 12.2 | 39.0 |
| Water | 55 | 176.0 |
| Slurry Density (ppg) | 13.92 | |

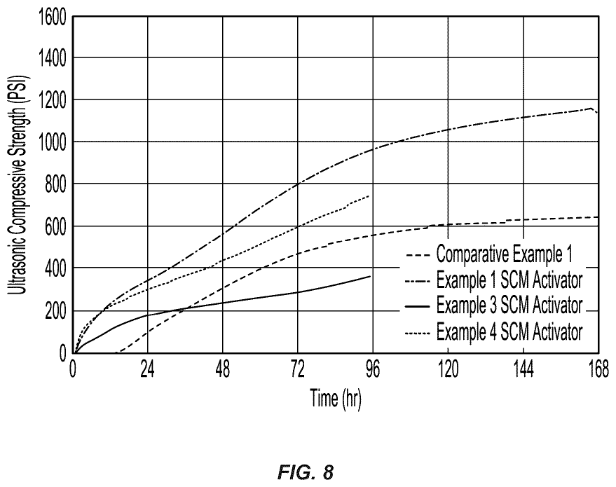

FIG. 8 is a graph of the compressive strength (PSI) of a comparative example 1, example 1 SCM activator, example 3 SCM activator, and example 4 SCM activator as measured using an ultrasonic cement analyzer, according to one example of the present disclosure. The graph demonstrates the compressive strength of the example SCM activators are generally better than the comparative example 1. For example, example 1 SCM activator was about 800 PSI at 72 hours while comparative example 1 was about 450 PSI. Additionally, example 4 SCM activator was about 600 PSI in the same amount of time.

The results demonstrate that including other additives in the formation step of the SCM Activators may positively affect slurry properties. For example, PCE (polycarboxylated ether) dispersant was included in the SCM Activators to help reduce the viscosity of the final cement slurry. The viscosities of slurries containing example 3 and 4 SCM Activators were reduced greatly as compared to the control (Table 10). For example, example 3 SCM activator had a viscosity of about 357 when measured at 100 rpm wile comparative example 1 measured 770 cP.

TABLE 10
Apparent viscosity (AVIS) comparison of SCM
Activators 1, 3, 4 and Control slurries.

| | AVIS Values at Specified RPM | | | | | | |
|---|---|---|---|---|---|---|---|
| | 3 | 6 | 30 | 60 | 100 | 200 | 300 |
| | rpm | rpm | rpm | rpm | rpm | rpm | rpm |
| Slurry | (cP) | (cP) | (cP) | (cP) | (cP) | (cP) | (cP) |
| Comparative | 5158 | 3550 | 1491 | 1026 | 779 | 536 | 431 |
| Example 1 | | | | | | | |
| Example 1 | 4348 | 2424 | 700 | 435 | 315 | 211 | 171 |
| SCM Activator | | | | | | | |
| Slurry | | | | | | | |
| Example 3 | 1989 | 1368 | 614 | 447 | 357 | 266 | 225 |
| SCM Activator | | | | | | | |
| Slurry | | | | | | | |
| Example 4 | 7605 | 3957 | 966 | 568 | 401 | 267 | 219 |
| SCM Activator | | | | | | | |
| Slurry | | | | | | | |

As evidenced by FIGS. 4, 6, and 8, the example activators outperformed comparative example 1 slurries in early strength at 80° F., a temperature consistently difficult for Low-Portland oilfield slurries containing supplementary cementitious materials. This early strength activation may translate into less WOC (waiting on cement) which in turn may translate into more cost savings. Example 1, 2, and 4 SCM Activators also demonstrated a higher compressive strength than the control formulation, making the low-Portland cement slurries more comparable to traditional Portland cement slurries in terms of strength and sheath integrity.

Ten second, 10 min, and 30 min gel strengths were performed on example 3 and 4 SCM activators. Example 3 and 4 SCM Activators 30 min gel strengths were “pegged out” as the material had hardened in the Rheovador cup. The tests were performed at room temperature. These results interestingly demonstrate the increased “set time” of example 3 and 4 SCM activators. For example, at room temperature the set time was about 40 minutes.

Some materials absorb water and CO₂ from the air. These materials may be difficult to work with because the absorbed components can make weighing inaccurate and change the chemistry of the materials. To keep these materials from being exposed to humid conditions, additional procedures and special packaging may be implemented. NaOH is one such material and it is also one of the components of the activators. Because the accelerators do not absorb CO₂ or water, special packaging and additional procedures would not be implemented. This will improve safety and shelf life. It will also reduce costs during packaging, shipping, storage, and handling.

As used below, any reference to a series of examples is to be understood as a reference to each of those examples disjunctively (e.g., “Examples 1-4” is to be understood as “Examples 1, 2, 3, or 4”). In some aspects, methods, and mixtures for thixotropic slurry material with enhanced reliability for use in a wellbore is provided according to one or more of the following examples:

Example 1 is a method comprising mixing water and an inorganic hydroxide to form a basic solution having a pH of greater than 10, adding, to the basic solution, an inorganic salt to produce an activator mixture; mixing the activator mixture for at least 5 minutes; drying the activator mixture to form a dried activated powder; grinding the dried activator powder; and sizing the dried activator powder to produce a final activator product, wherein the final activator product is addable to a low Portland cement mixture to reduce a set time of the low Portland cement mixture.

Example 2 is the method of example 1, wherein the final activator powder has a diameter of less than 300 microns after sizing.

Example 3 is the method of any one of examples 1-2, wherein the low Portland cement mixture comprises less than 40% Portland cement by weight of a blended cement composition.

Example 4 is the method of any one of example 1-3, further comprising adding a supplementary cementitious material to the low Portland cement mixture to produce a blended cement composition, and adding water to the cement mixture to produce a cement slurry having a density of from about 5 lbs/gallon to 25 lbs/gallon.

Example 5 is the method of any one of example 1-4, further comprising positioning the cement slurry downhole within a wellbore during a cementing operation.

Example 6 is the method of any one of examples 1-5, wherein the supplementary cementitious material is greater than 40% by weight of the blended cement composition.

Example 7 is the method of any one of examples 1-6, wherein the cement slurry has a viscosity of less than 1200 centipoise when measured at 100 rpm.

Example 8 is the method of any one of examples 1-7, wherein drying the activator mixture comprises baking the activator mixture in an oven for at least 24 hours at a temperature range of from 140° C. to 200° C.

Example 9 is the method of any one of examples 1-8, wherein the inorganic hydroxide comprises sodium hydroxide, potassium hydroxide, barium hydroxide, lithium hydroxide, calcium hydroxide, ammonium hydroxide, rubidium hydroxide, magnesium hydroxide, or any combination thereof, and wherein a concentration of the inorganic hydroxide is at least 50% by weight of solution.

Example 10 is the method of any one of examples 1-9, wherein the inorganic salt comprises calcium carbonate, cement kiln dust, calcium sulfate, calcium phosphate, sodium phosphate, calcium silicate, or any combination thereof.

Example 11 is the method of any one of examples 1-10, further comprising adding at least one additive, wherein the at least one additive comprises a dispersant an accelerator, a viscosifier, or a combination thereof, wherein the dispersant comprises polycaboxylate ethers, a combination of sodium formate and sulfonic acid salt, naphthalene formaldehyde sulfonated condensate, or any combination thereof.

Example 12 is a A composition comprising a dry cement activator produced from a solution having a pH of greater than 10 and an inorganic salt, at least one additive comprising a dispersant, an accelerator, a viscosifier, or a combination thereof, and a dry cement mixture.

Example 13 is the composition of example 12, wherein the cement mixture, combined with water, is activatable at a temperature of below about 150° F.

Example 14 is the composition of any one of example 12-13, wherein the cement mixture has a compressive strength of greater than 50 PSI in under 3 hours when mixed with water.

Example 15 is the composition of any one of examples 12-14, wherein the solution having a pH of greater than 10 comprises water and an inorganic hydroxide, wherein the inorganic hydroxide comprises sodium hydroxide, potassium hydroxide, barium hydroxide, lithium hydroxide, calcium hydroxide, ammonium hydroxide, rubidium hydroxide, magnesium hydroxide, or any combination thereof, and wherein a concentration of the inorganic hydroxide is at least 30% by weight of solution.

Example 16 is the composition of any one of examples 12-15, wherein the inorganic salt comprises calcium carbonate, cement kiln dust, and calcium sulfate, calcium phosphate, sodium phosphate, calcium silicate, or any combination thereof.

Example 17 is the composition of any one of examples 12-16, wherein the dispersant comprises polycaboxylate ethers, a combination of sodium formate and sulfonic acid salt, acetone formaldehyde sulfonated condensate, naphthalene formaldehyde sulfonated condensate, or any combination thereof, and wherein the viscosifier comprises polysaccharide biopolymer, hydroxyethyl cellulose and derivatives, or any combination thereof.

Example 18 is the composition of any one of examples 12-17, further comprising a fluid loss additive, wherein the fluid loss additive comprises polyacrylamide copolymer, polyvinyl alcohol, or any combination thereof.

Example 19 is the composition of any one of examples 12-18, wherein the dry cement mixture comprises less than 30% Portland cement by weight of a blended cement mixture.

Example 20 is the composition of any one of examples 12-19, wherein the accelerator comprises sodium chloride, calcium chloride, sodium silicate, sodium sulfate, sodium aluminate, sodium hexametaphosphate, or any combination thereof.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A method comprising:
mixing water and an inorganic hydroxide to form a basic solution having a pH of greater than 10;
adding, to the basic solution, an inorganic salt to produce an activator mixture;
mixing the activator mixture for at least 5 minutes;
drying the activator mixture to form a dried activated powder;
grinding the dried activator powder; and
sizing the dried activator powder to produce a final activator product, wherein the final activator product is addable to a low Portland cement mixture to reduce a set time of the low Portland cement mixture.

2. The method of claim 1, wherein the final activator powder has a diameter of less than 300 microns after sizing.

3. The method of claim 1, wherein the low Portland cement mixture comprises less than 40% Portland cement by weight of a blended cement composition.

4. The method of claim 3, further comprising:
adding a supplementary cementitious material to the low Portland cement mixture to produce a blended cement composition; and
adding water to the cement mixture to produce a cement slurry having a density of from about 5 lbs/gallon to 25 lbs/gallon.

5. The method of claim 4, further comprising:
positioning the cement slurry downhole within a wellbore during a cementing operation.

6. The method of claim 4, wherein the supplementary cementitious material is greater than 40% by weight of the blended cement composition.

7. The method of claim 4, wherein the cement slurry has a viscosity of less than 1200 centipoise when measured at 100 rpm.

8. The method of claim 1, wherein drying the activator mixture comprises baking the activator mixture in an oven for at least 24 hours at a temperature range of from 140° C. to 200° C.

9. The method of claim 1, wherein the inorganic hydroxide comprises sodium hydroxide, potassium hydroxide, barium hydroxide, lithium hydroxide, calcium hydroxide, ammonium hydroxide, rubidium hydroxide, magnesium hydroxide, or any combination thereof, and wherein a concentration of the inorganic hydroxide is at least 50% by weight of solution.

10. The method of claim 1, wherein the inorganic salt comprises calcium carbonate, cement kiln dust, calcium sulfate, calcium phosphate, sodium phosphate, calcium silicate, or any combination thereof.

11. The method of claim 1, further comprising:
adding at least one additive, wherein the at least one additive comprises a dispersant an accelerator, a viscosifier, or a combination thereof, wherein the dispersant comprises polycaboxylate ethers, a combination of sodium formate and sulfonic acid salt, naphthalene formaldehyde sulfonated condensate, or any combination thereof.

12. A composition comprising:
a dry cement activator produced from a solution having a pH of greater than 10 and an inorganic salt;
at least one additive comprising a dispersant, an accelerator, a viscosifier, or a combination thereof; and
a dry cement mixture.

13. The composition of claim 12, wherein the cement mixture, combined with water, is activatable at a temperature of below about 150° F.

14. The composition of claim 12, wherein the cement mixture has a compressive strength of greater than 50 PSI in under 3 hours when mixed with water.

15. The composition of claim 12, wherein the solution having a pH of greater than 10 comprises water and an inorganic hydroxide, wherein the inorganic hydroxide comprises sodium hydroxide, potassium hydroxide, barium hydroxide, lithium hydroxide, calcium hydroxide, ammonium hydroxide, rubidium hydroxide, magnesium hydroxide, or any combination thereof, and wherein a concentration of the inorganic hydroxide is at least 30% by weight of solution.

16. The composition of claim 12, wherein the inorganic salt comprises calcium carbonate, cement kiln dust, and calcium sulfate, calcium phosphate, sodium phosphate, calcium silicate, or any combination thereof.

17. The composition of claim 12, wherein the dispersant comprises polycaboxylate ethers, a combination of sodium formate and sulfonic acid salt, acetone formaldehyde sulfonated condensate, naphthalene formaldehyde sulfonated condensate, or any combination thereof, and wherein the viscosifier comprises polysaccharide biopolymer, hydroxyethyl cellulose and derivatives, or any combination thereof.

18. The composition of claim 12, further comprising a fluid loss additive, wherein the fluid loss additive comprises polyacrylamide copolymer, polyvinyl alcohol, or any combination thereof.

19. The composition of claim 12, wherein the dry cement mixture comprises less than 30% Portland cement by weight of a blended cement mixture.

20. The composition of claim 12, wherein the accelerator comprises sodium chloride, calcium chloride, sodium silicate, sodium sulfate, sodium aluminate, sodium hexametaphosphate, or any combination thereof.
